(19) United States
(12) Patent Application Publication
(10) Pub. No.: US 2010/0090143 A1
(43) Pub. Date: Apr. 15, 2010

(54) Dual locking valve

(76) Inventor: Norbert J. Kot, Brookfield, WI (US)

Correspondence Address: RYAN KROMHOLZ & MANION, S.C., POST OFFICE BOX 26618, MILWAUKEE, WI, 53226, US

(21) Appl. No.: 12/583,973

(22) Filed: Aug. 28, 2009

Related U.S. Application Data
(60) Provisional application No. 61/190,391, filed on Aug. 28, 2008.

(51) Int. Cl. F16K 31/16; F16K 31/02

(52) U.S. Cl. 251/129.15; 251/324

(57) ABSTRACT

A dual locking valve assembly includes two check valve elements in two cartridge bores. Each check valve element opens to permit forward flow of fluid under pressure in the cartridge bore from an input bore to an output bore. The check valve element closes to block back flow of fluid under pressure in the cartridge bore from the output bore towards the input bore. The back flow of fluid under pressure exerts a closing force upon the check valve element from within the output chamber. A counter force generating element, or pilot element, communicates with the valve element, to selectively open the valve, even in the presence of back flow pressure. The pilot element exists as a fluid crossover path from one cartridge bore to the other.

### RELATED APPLICATIONS

This application claims the benefit of U.S. Provisional Patent Application Ser. No. 61/190,391, filed 28 Aug. 2008, and entitled “Dual Locking Flow Control Valve,” which is incorporated herein by reference in its entirety.

### FIELD OF THE INVENTION

The invention relates to fluid pressure operated systems and devices, particularly those featuring at least partially fluid tight operation.

### BACKGROUND OF THE INVENTION

A very popular valve in the automation industry is a 4-way directional control valve. This valve consists of a manifold with a set of flow control solenoids mounted onto the manifold. The solenoids shift a spool using a combination of air and electricity to redirect the flow of the air through the manifold. The spool and the bore within which it slides are often constructed of metal. The steel spool slides inside the metal bore to shift the direction of fluid, such as air, oil or water to different ports. This metal-on-metal seal has a tendency to leak after operating for a short period of time.

There remains a need for a valve that can solve this tendency to leak problem, either by being an add-on to the leaking valve, or by being integrated into the valve, which, in turn, will lead to increased safety and operating life. There is also a need for easy attachment and compact size.

### SUMMARY OF THE INVENTION

The invention provides a dual locking (DL) valve that can be easily attached to a manifold to solve the leaking problem. This is advantageous in automated systems that must hold position without drifting over time or where parts must be held in place in the event of a drop in pressure and is also advantageous for use in leak testing systems. A second advantage is that no mounting holes or extra space is required for mounting the valve. The valve may mount directly to a 4-way valve manifold with two fasteners. A third advantage is no additional plumbing is required, i.e., all plumbing is internal. The DL valve also has a manual release so that during system repair or during an emergency stop, the potential energy of the trapped air can be released. A variety of options can also be added, including flow controls, adjustable pilot, sensor ports, auto release with metered exhaust, manual exhaust to atmosphere.

Additional advantages of the invention include:
1. The addition of the DL valve makes the entire valve assembly fluid tight on both the output ports, which eliminates drift due to leaky or worn spools.
2. The DL valve can be added without having to drill holes for mounting the valve, i.e., direct mount to the base manifold.
3. No added plumbing is required, so time and money are saved.
4. Fast and easy to attach the DL valve—saving time and money, i.e., the DL may be assembled in approximately two minutes. The DL may also be added after a machine has already been assembled.
5. A manual release allows the release of trapped air from both ports independently.
6. The flow control option controls the velocity of the pneumatic device, for use on single manifolds.
7. The adjustable pilot option, also for use on single manifolds, can be used to overcome differential pressure problems and set for quicker stopping.
8. An embodiment of the DL valve incorporates compatibility with the International Organization for Standardization (ISO) port interface specification ISO 15407-2 (with electrical connector) or 15407-1 (without electrical connector), directed to pneumatic fluid power, five-port directional control valves.

Generally, a valve according to the present invention includes a valve body having first, second, third and fourth reentrant bores formed therein. The valve body further includes a first cartridge bore in fluid communication with the first third reentrant bores and a second cartridge bore in fluid communication with the second and fourth reentrant bores. The cartridge bores preferably include a piston bore, an input counterbore, an output counterbore and a bearing sleeve counterbore. At least partially within each cartridge bore is a piston cartridge. Each piston cartridge includes a longitudinal piston rod, a first piston head secured to one end of the piston rod, and a second piston head secured to a second end of the piston rod. A poppet member is slidably disposed on the piston rod, biased in a poppet bias direction by a poppet bias spring. The valve body further includes a first fluid channel in fluid communication with the first reentrant bore and the second cartridge bore, preferably with its respective piston bore. Separated from the first fluid channel is a second fluid channel in fluid communication with the second reentrant bore and the first cartridge bore, preferably with its respective piston bore. A plurality of nonintersecting throughbores may be formed through said valve body. The plurality of nonintersecting throughbores may number three to five.

According to an embodiment of a valve according to the present invention, the valve body may be a unitary member. The valve body may be at least substantially parallelepiped in shape, including a front surface, back surface, top surface, bottom surface, left surface and right surface. A plurality of nonintersecting throughbores may be formed through the valve body, including through the bottom surface and the top surface.

According to an embodiment of a valve according to the present invention, the cartridge bores may extend through and include the left surface and the right surface. The first reentrant bore and the second reentrant bore may be formed into the valve body through the top surface. The third reentrant bore and the fourth reentrant bore may be formed into the valve body through the bottom surface.

According to an embodiment of a valve according to the present invention, the valve may further include a manual release mechanism including a manual release cover, a manual release gasket and first and second manual release plungers. The manual release cover includes a pilot channel formed therein and is coupled to the valve body to cover one end of the cartridge bores. The manual release gasket includes a first plunger aperture, a second plunger aperture and a gasket pilot hole formed therethrough, where the gasket is situated between a portion of the manual release cover and the valve body placing the gasket pilot hold in fluid communication with the pilot channel. The first manual release plunger extends through the manual release cover, through the first plunger aperture in the gasket and into the first piston bore so as to be contactable with the first piston cartridge. The second manual release plunger extends through the manual release cover, through the second plunger aperture in the gasket and into the second piston bore so as to be contactable with the second piston cartridge.

According to an embodiment of a valve according to the present invention, the valve may include a flow control mechanism. The flow control mechanism may include a mounting plate including a first adjusting aperture and a second adjusting aperture formed therethrough. A first threaded adjusting screw may extend through the first adjusting aperture into the first cartridge bore, preferably the output counterbore thereof, and a second threaded adjusting screw may extend through the second adjusting aperture into the second cartridge bore, preferably the output counterbore thereof. A first lock nut may be threaded onto the first adjusting screw, adapted to selectively prevent rotation of the first adjusting screw with respect to the mounting plate, and a second lock nut may be threaded onto the second adjusting screw, adapted to selectively prevent rotation of the second adjusting screw with respect to the mounting plate. The mounting plate is preferably coupled to the valve body to cover one end of the cartridge bores.

A system according to the present invention includes a fluid controlled actuator, a manifold in fluid communication with the fluid controlled actuator, first and second check valves in fluid communication with the manifold, and a fluid controlled solenoid assembly in fluid communication with the check valves. The fluid controlled actuator generally includes a first fluid chamber and a second fluid chamber. Such fluid controlled actuator, or fluid motor, may be a linear actuator comprising a plunger coupled to an actuating rod, where the plunger separates the first fluid chamber and the second fluid chamber. The manifold generally includes a first fluid port in fluid communication through a first fluid line with the first chamber of the fluid actuator and a second fluid port in fluid communication through a second fluid line with the second chamber. The manifold further includes a third fluid supply port. The first check valve includes a first check valve input, a first check valve output, and a first check valve pilot input, wherein the first check valve output is in fluid communication with the first fluid port on the manifold. The second check valve includes a second check valve input, a second check valve output, and a second check valve pilot input, wherein the second check valve output is in fluid communication with the second fluid port on the manifold. Also, the second check valve input is in fluid communication with the first check valve pilot input, and the second check valve pilot input is in fluid communication with the first check valve input. The fluid control solenoid assembly includes a fluid flow control spool that is moveable between a first position in which the fluid supply port is in fluid communication with the first check valve input, and a second position in which the fluid supply port is in fluid communication with the second check valve input.

According to one aspect of a system according to the present invention, when a supply fluid pressure in the fluid supply port is lost, the first check valve and the second check valve are closed.

According to one aspect of a system according to the present invention, when the fluid control solenoid assembly is in either of the first and second positions and when the supply fluid pressure is greater than either of the first fluid pressure or the second fluid pressure by a predetermined flow amount, respectively, both check valves are opened.

According to an aspect of a system according to the present invention, when the fluid control solenoid assembly is in the first position and when the supply fluid pressure is greater than the first fluid pressure, the supply fluid flows from the supply fluid port through the first check valve, through the first fluid line and into the first chamber, and a first exhaust fluid flows from the second chamber, through the second fluid line and through the second check valve.

According to an aspect of a system according to the present invention, when the fluid control solenoid assembly is in the second position and when the supply fluid pressure is greater than the second fluid pressure, the supply fluid flows from the supply fluid port through the second check valve, through the second fluid line and into the second chamber, and exhaust fluid flows from the first chamber, through the first fluid line and through the first check valve.

These and other features and advantages of the invention will become apparent from the following description and drawings.

### BRIEF DESCRIPTION OF THE DRAWINGS

FIGS. 1A, 1B and 1C form a schematic representation of a first embodiment of a system according to the present invention.

FIG. 1B is a cross-section view taken along line 1B of FIG. 1A.

FIG. 1C is a cross-section view taken along line 1C of FIG. 1A.

FIG. 2 is a front top right perspective view of a first embodiment of a valve according to the present invention.

FIG. 3 is a front bottom left perspective view of the embodiment of FIG. 2.

FIG. 4A is a cross section partial assembly view taken along line 4A-4A of FIG. 2.

FIG. 4B is a right elevation, partial exploded view of the embodiment of FIG. 2.

FIG. 5A is a cross section view of a second embodiment of a valve according to the present invention taken generally along a line similar to line 4A-4A of FIG. 2, but further including a flow control option.

FIG. 5B is a left elevation view of the embodiment of FIG. 5A.

FIG. 6A is a cross section view of a third embodiment of a valve according to the present invention taken generally along a line similar to line 4A-4A of FIG. 2, but further including a flow control option.

FIG. 6B is a left elevation view of the embodiment of FIG. 6A.

FIGS. 7A, 7B and 7C form a schematic representation of a first embodiment of a system according to the present invention.

FIG. 7B is a cross-section view taken along line 7B-7B of FIG. 7A.

FIG. 7C is a cross-section view taken along line 7C-7C of FIG. 7A.

FIG. 8 is a front top right perspective view of a known manifold.

FIG. 9 is a front top right perspective view of a fourth embodiment of a valve according to the present invention.

FIG. 10 is a front bottom left perspective view of the embodiment of FIG. 9.

FIG. 11A is a partially exploded cross section view taken along line 11A-11A of FIG. 9.

FIG. 11B is an assembly view of a piston cartridge shown in FIG. 11A.

FIG. 12A is a bottom plan view of the embodiment of FIG. 9.

FIG. 12B is a plan view of a gasket used with the embodiment of FIG. 9.

FIG. 13 is a top plan view of a fifth embodiment of a valve according to the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

### I. A System

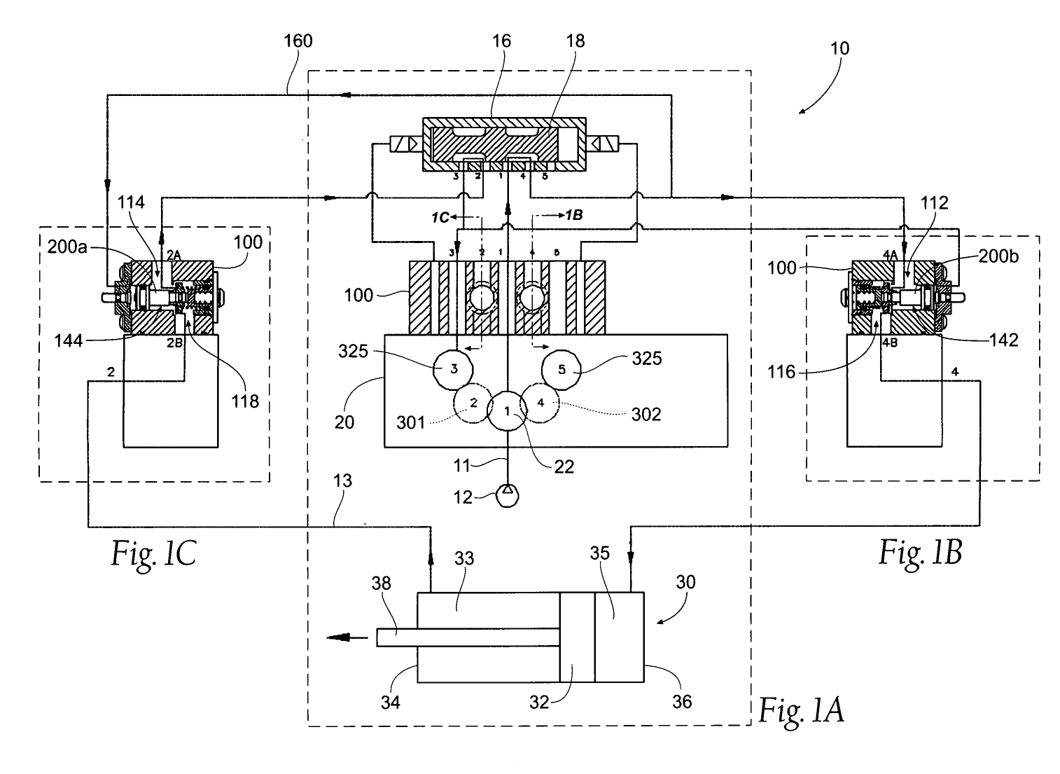

Turning to the figures, FIGS. 1A, 1B and 1C provide an embodiment of a system 10 in which an embodiment of a dual locking valve according to the present invention may be used. Generally, air pressure from a supply source 12, is directed through a manifold 20 and through an embodiment of a dual locking valve 100, to controlling solenoids 16. An electrical signal (not shown) sent to the solenoids 16 shifts a spool 18 contained therein, directing air pressure back through the dual locking valve 100 and out the manifold 20 to a working air cylinder 30. A plunger 32, located at least partially in the air cylinder 30, applies force to an object (not shown), as is known.

The air cylinder 30 has a rod chamber 33 and a plunger chamber 35. The rod chamber 33 is located between the plunger 32 and a rod end 34 of the cylinder 30, and the plunger chamber 35 is located between the plunger 32 and the plunger end 36 of the cylinder 30. In order for the plunger 32 to move towards the rod end 34 of the cylinder 30, the rod chamber 33 of the air cylinder 30 must have an exhaust path to the atmosphere. This is accomplished by opening the piston cartridge 200a opposite the pressurized piston cartridge 200b.

As the piston 32 moves to extend the cylinder rod 38, the air in the rod chamber 33 is pushed out. The exhaust air 13 travels back into the manifold 20, through the valve 100, through the solenoids 16, back through the valve 100, and out the manifold 20 to atmosphere.

In the event that the supply air pressure 11 is lost or a drop in that pressure occurs, the valve 100 will trap air on both sides of the air cylinder 30, locking the plunger 32 in a safe, at least substantially static position.

### II. Valve

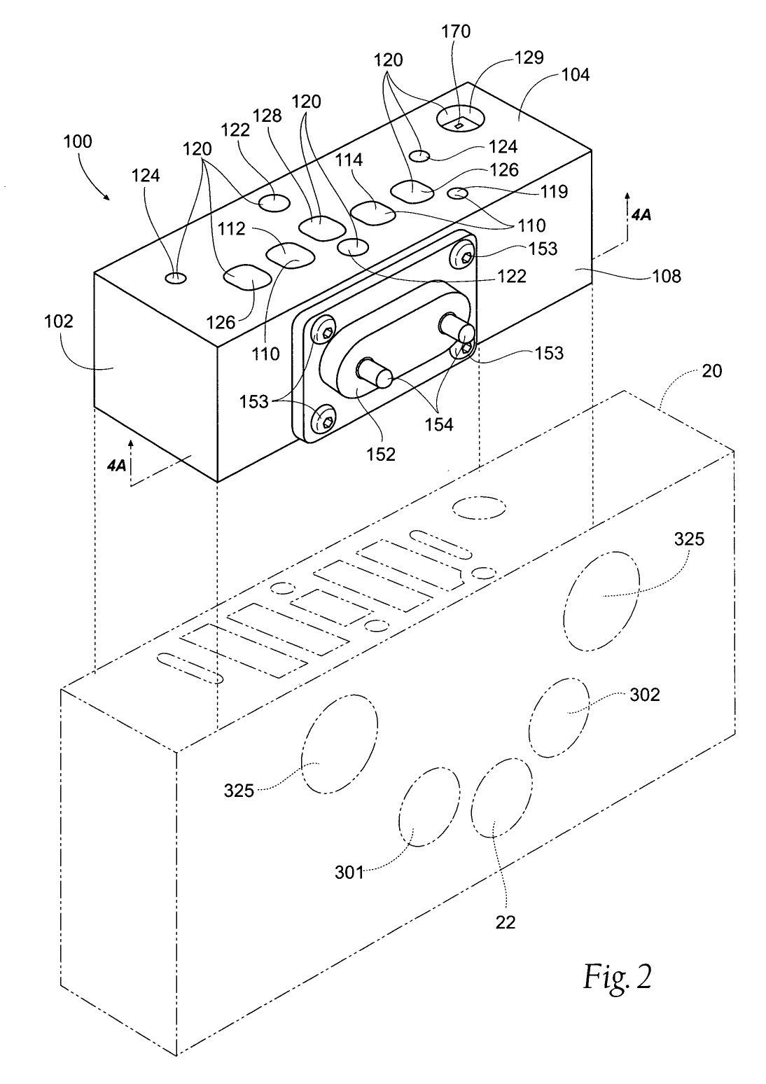

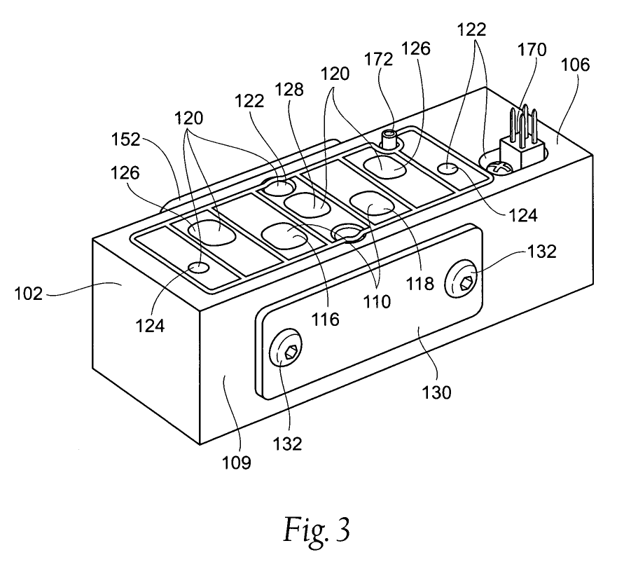

Turning now to FIG. 2 and FIG. 3, an embodiment 100 of a valve according to the present invention is shown. Generally, the valve 100 includes a valve body 102, into which a plurality of reentrant bores 110 are formed, and through which a plurality of throughbores 120 may be formed. A first reentrant bore 112 and a second reentrant bore 114 may be formed in a spaced relationship into the valve body 102. A third reentrant bore 116 and a fourth reentrant bore 118 may also be formed in a spaced relationship into the valve body 102. The first and second reentrant bores 112,114 may be formed into the same surface of the valve body 102, such as a top surface 104 thereof. The third and forth reentrant bores 116,118 may be formed into the same surface of the valve body 102, such as a bottom surface 106 thereof. The top surface 104 and the bottom surface 106 may be substantially planar surfaces that may be at least substantially parallel to each other. Another reentrant bore that may be provided is a locating, or registration, bore 119. The registration bore 119 may also be formed into the top surface 104.

The throughbores 120 provided may serve a variety of purposes. For instance, a first pair of mounting throughbores 122 may be provided. A second pair of control throughbores 124 may provide direct flowthrough to enable control of the solenoid 16. A third pair of exhaust throughbores 126 may be provided. A supply air throughbore 128 and an electrical connector throughbore 129 may also be provided. It is to be understood that some or all of the throughbores 120 may be utilized in any given embodiment. The throughbores 120 preferably extend completely through the thickness of the valve body 102, such as between and including the top surface 104 and the bottom surface 106.

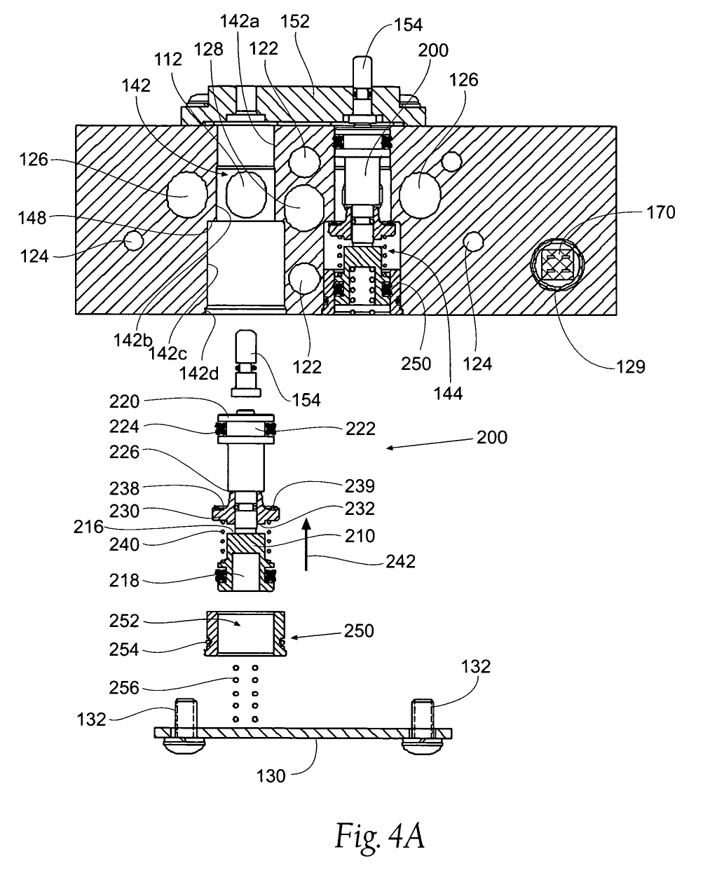

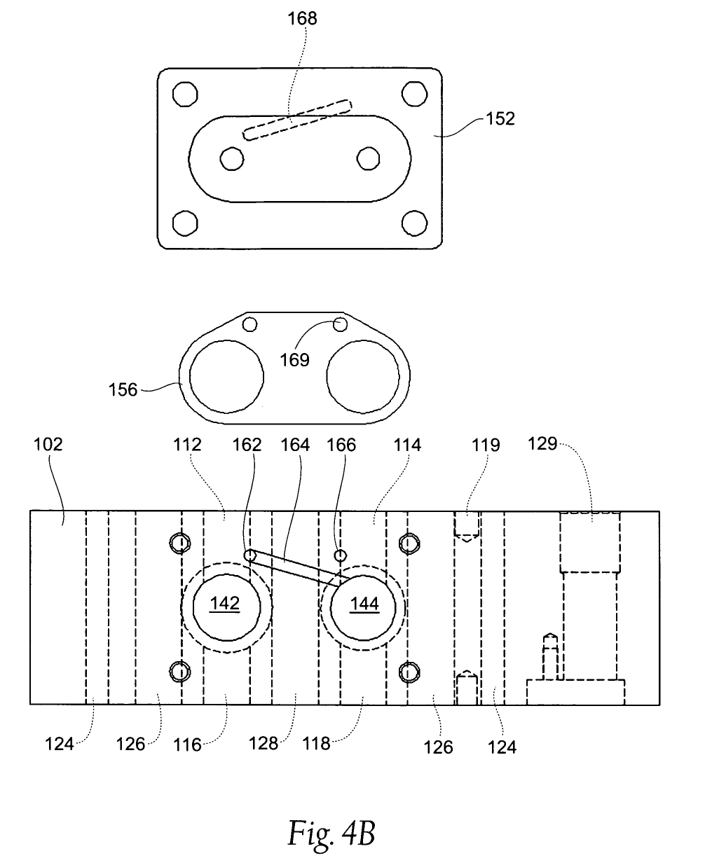

Also with reference to FIG. 4A, disposed within the valve body 102 are a first cartridge bore 142 and a second cartridge bore 144. The first cartridge bore 142 is in fluid communication with the first reentrant bore 112 and the third reentrant bore 116, and the second cartridge bore 144 is in fluid communication with the second reentrant bore 114 and the fourth reentrant bore 118. The cartridge bores 142,144 may be formed substantially orthogonal to their respective reentrant bores 112,116 and 114,118.

Each cartridge bore 142,144 is preferably formed as a throughbore which may include one or more counterbores.

Within each cartridge bore is a piston cartridge 200. The cartridges 200 are interchangeable, fluid tight, and function to hold air in the cylinder 30 in the event of a pressure loss or a change in pressure. The piston cartridge 200 generally includes a longitudinal piston rod 202, a first piston head 210, a second piston head 220, and a poppet member 230 slidably disposed on the piston rod 202 and located generally between the first and second piston heads 210,220. The substantially free sliding movement of the poppet member 230 generally, without pilot pressure, checks air in one direction and allows free flow in the opposite direction. The first piston head 210 is connected to a first end 204 of the piston rod 202, and the second piston head 220 is connected to a second end 206 of the piston rod 202, which may include a threaded engagement means 208 to cooperate with the second piston head 220. The first piston head 210 is preferably formed with an annular piston seal groove 212 about its circumference, which accommodates placement of a first piston seal 214, such as a grooved elastomeric O-ring. The first piston head 210 also preferably provides a first poppet stop surface 216 and a piston bias bore 218 adapted to accept a piston bias spring, such as an end cap spring 256. The second piston head 220 is preferably formed with an annular piston seal groove 222 about its circumference, which accommodates placement of a second piston seal 224, such as a grooved elastomeric O-ring. The second piston head 220 also preferably provides a second poppet stop surface 226.

The poppet member 230 is slidably disposed on the piston rod 202, the piston rod 202 preferably extending through the poppet member 230. Situated between the poppet member 230 and the piston rod 202, there may be a rod gasket or seal 203 such as an elastomeric O-ring that is disposed in an annular groove 205 formed about the piston rod 202. Situated between the poppet member 230 and the first piston head 210 is a poppet bias spring 240, which biases the poppet member 230 in a bias direction 242, which is generally towards the second piston head 220. The poppet member 230 itself may generally be formed as a frustoconical member extending between a first end 232 and a second end 234, and further including an annular sealing flange 236 disposed thereabout. The annular sealing flange 236 includes a sealing surface 238, which, when the piston cartridge 200 is assembled, generally faces towards the second piston head 220. Disposed on and/or recessed into the sealing surface 238 is a poppet gasket 239, which may be formed of an elastomeric material.

The piston cartridge 200 may generally be assembled by situating the rod gasket 203 in the annular groove 205 provided on the piston rod 202. The poppet bias spring 240 may be placed on the rod 202, resting against the first piston head 210. The poppet member 230 may be slid onto the piston rod 202 and the second piston head 220 may be secured to the piston rod 202. The piston seals 214,224 are placed around their respective piston heads 210,220.

As indicated above, the cartridge bores 142,144 are provided with preferably at least one counterbore. For clarity in this section, only the first cartridge bore 142 will be described, with the understanding that the description also applies to the second cartridge bore 144. The cartridge bore 142 includes a piston bore 142a, an input counterbore 142b, an output counterbore 142c, and a bearing sleeve counterbore 142d. The first, or input reentrant bore 112 intersects the cartridge bore 142 at the input counterbore 142b and the third, or output reentrant bore 116 intersects the cartridge bore 142 at the output counterbore 142c. The output counterbore 142c provides a poppet seat, or sealing ledge 148 and further provides sufficient clearance for sliding movement of the poppet member 230 and desired fluid flow. To maintain the piston cartridge 200 in a preferred orientation, a bearing sleeve 250 may be used. The bearing sleeve 250 includes a piston aperture 252, into which the first piston head 210 may be situated, the bearing sleeve 250 circumferentially contacting the first piston seal 214. Disposed around the bearing sleeve 250 is preferably a bearing sleeve seal 254, such as an elastomeric O-ring, which is adapted to sealingly engage the output counterbore 142c provided in the cartridge bore 142. The second piston head 220 is received into the piston bore 142a.

In the first embodiment 100, the piston cartridges 200 and bearing sleeves 250 are maintained in the valve body 102 by a piston cover 130, which generally extends to cover one side of the cartridge bores 142,144 and is secured to the valve body 102, such as by using a plurality of threaded fasteners 132. On the opposite end of the cartridge bores 142,144 from the piston cover 130, a manual release mechanism 150 may be provided. The manual release mechanism 150 includes a manual release cover 152, a pair of manual release plungers 154, and a manual release gasket 156. The manual release plungers 154 are flanged posts that extend through the manual release cover 152, sealed thereto by a manual release plunger gasket 158, such as an elastomeric O-ring, through the gasket 156 to contact the second piston head 220 or second piston rod end 206 to enable manual override of the piston bias spring 256. This allows the release of air that may be trapped in the air cylinder 30.

The manual release cover 152, the manual release gasket 156 and certain features of the valve body 102 provide pilot fluid crossover fluid paths. That is, it has been found desirable to place the first reentrant bore 112 in fluid communication with the second piston bore 144a and the second reentrant bore 114 in fluid communication with the first piston bore 142a. The first reentrant bore 112 is placed in fluid communication with the second piston bore 144a through a first crossover fluid path 160. The first crossover fluid path 160 is created partially by a first pilot input reentrant bore 162 formed into the valve body 102, terminating in fluid communication with the first reentrant bore 112. A first pilot channel 164 is formed in the valve body 102 thereby fluidly coupling the first pilot reentrant bore 162, and thus the first reentrant bore 112, to the second piston bore 144a. The second reentrant bore 114 is placed in fluid communication with the first piston bore 142a through a second crossover fluid path 165. The second crossover fluid path 165 is created partially by a second pilot input reentrant bore 166 formed into the valve body 102, terminating in fluid communication with the second reentrant bore 114. A second pilot channel 168 is formed in the manual release cover 152, separated from the first pilot channel 164 by the manual release gasket 156. The second pilot channel 168 fluidly couples the second pilot reentrant bore 166, and thus the second reentrant bore 114, through a gasket pilot hole 169, to the first piston bore 142a.

### III. Detailed Operation

Turning back to FIG. 1, the operation of the system 10 in moving the plunger 32 in a single direction is described herein. It will be readily understood by a person of ordinary skill in the art that movement of the plunger 32 in the opposite direction would simply involve a shift in the solenoid spool 18, and the operation would be identical, with each piston cartridge 200 swapping functionality with the other. Air pressure 11 from the supply source 12, is connected to the supply port 22 on the manifold 20. This port 22 is placed in fluid communication with the supply throughbore 128 on the valve 100, thereby providing a direct flow path to the solenoids 16. The solenoid 16 shifts the spool 18 with a combination of air pressure and an electrical signal, to direct the flow of the air pressure 11 to the first reentrant bore 112, causing the poppet member 230 located in the first cartridge bore 142 to open due to a buildup of air pressure. The poppet member 230 is biased toward the poppet seat 148 by the poppet bias spring 240, which allows the poppet member 230 to open when there is a 1-2 psi pressure difference across the poppet member 230. With the poppet member 230 open, or spaced from the poppet seat 148, the air moves through the first reentrant bore 112, through the first cartridge bore 142 and into the third reentrant bore 116. The third reentrant bore 116 is in fluid communication with a first control port 301 on the manifold 20, which is in fluid communication with the plunger chamber 35 of the air cylinder 30.

The air in the rod chamber 33 needs a passage to exhaust to atmosphere. This is accomplished by using the pressure side of the valve 100 to open the cartridge 200 on the exhaust side of the circuit. This is accomplished by using the crossover fluid paths 160,165. Through one of these paths at a time, the air from a reentrant bore on the pressure side unseats the poppet member 230 in the exhaust cartridge 200 allowing air to flow from the fourth reentrant bore 118, which is in fluid communication with a second control port 302 on the manifold 20, to the second reentrant bore 114. The open path allows air to escape from the rod chamber 33 of the cylinder 30 up to the solenoids 16 where there is an open flow through the solenoid 16 and back into the valve 100 through an exhaust throughbore 126 which is connected to the manifold 20 and which is exhausted to atmosphere out of one of the exhaust ports 325 therein.

The cartridges 200 fit into the valve body 102, at least partially, but preferably entirely within the cartridge bores 142,144. The cartridge 200 slides into the cartridge bore 142, where the second piston seal 224 contacts the piston bore 142a, the poppet member 230 is in the output counterbore 142c and is biased toward the poppet seat 148 resulting in an air-tight seal on the poppet seat 148. The bearing sleeve 250 and the bearing sleeve seal 254 slide into the output counterbore 142c and rest on the bearing sleeve counterbore 142d.

The end cap spring 256 is placed in the end of the first piston head 210, which may be formed as an integral part of the piston rod 202, to bias the entire cartridge 200 toward the poppet seat 148. The entire procedure is repeated for the second cartridge 200. When both cartridges are in place, the piston cover 130 is fastened in place with screws 132. When the cover 130 is in place, the poppet members 230 are closed against the poppet seats 148.

The solenoids 16 may likely require electrical signals to operate. Normally, the solenoids 16 are mounted directly to the manifold 20, thereby allowing a direct connection between an electrical plug on the solenoids 16 and an electrical jack on the manifold 20. When the valve 100 is placed between the manifold 20 and the solenoids 16, however, the electrical signal to power the two solenoids may be carried by an electrical passthrough connector 170 on the valve 100 that plugs into a female connector on the manifold 20 and a male connector on the solenoids 16. The air pressure required to shift the spool 18 in the solenoid assembly 16, is supplied by the two control throughbores 124 in the valve body 102.

The air passages between the DL valve and the manifold are sealed with a gasket (28). The groove to retain the gasket is machined into the DL block (2). The air passages between the solenoids (4) and the DL valve are sealed with a gasket attached to the solenoids (4).

The entire assembly comprising the solenoids 16, the valve 100 and the manifold 20 may be held together with just two standoffs (not shown) that have a male thread on one end that threads into the manifold 20 and a female thread that connects to the solenoids 16. The standoffs fit into the mounting throughbores 122 in the valve body 102 so that a standoff seal can seal air-tight in the standoff bore 122. A small locating, or registration pin 172 helps to locate or align the connection between the manifold 20 and the valve 100, and may cooperate with a registration bore 319 on the manifold 20.

The two control throughbores 124 provided through the valve body 102 supply air from the manifold 20 to the two solenoids 16 that help to open and close air passages in conjunction with electronic signals to help shift the spool 18 from side to side.

### IV. Valve Options

A. Flow Controls

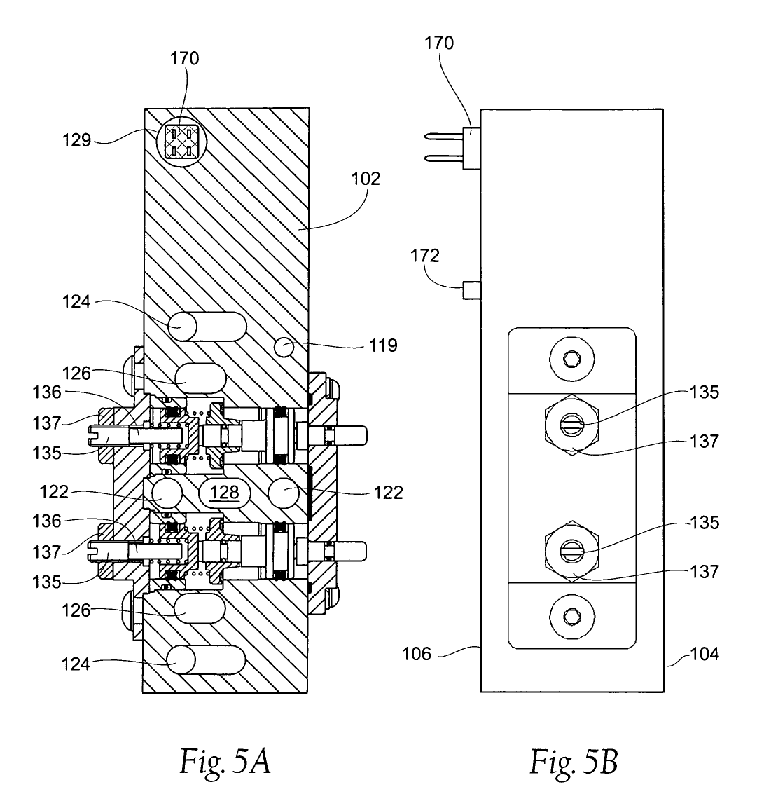

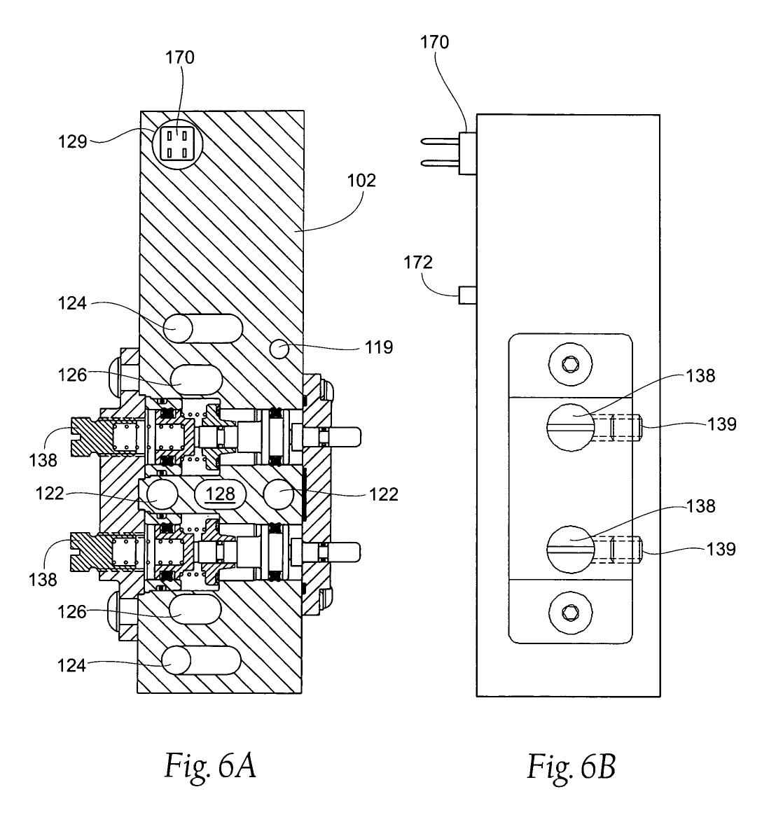

One option is a flow control for both cartridges 200 to control cylinder speed by metering airflow from the air cylinder 30. FIGS. 5A and 5B depict a second embodiment of a valve according to the present invention, where, instead of a simple piston plate 130, a flow control mechanism 133 is provided in its place. An flow control adjusting screw 135 is added to the end of each cartridge that limits the movement of the poppet member 230 when the cartridge 200 is pressurized to the open position. A lock nut 137 may be used to lock the adjusting screw 135 in position. Metering out is the preferred method of controlling air cylinder speed. This also eliminates the need to add an extra valve to control the air cylinder speed.

B. Adjustable Pilots

An additional or alternative option gives the valve 100 the ability to adjust the air pressure required to shift the cartridges 200 and open the valve. The end cap spring 256 may not function correctly in cases where there is a large pressure difference between the cylinder advance and retract circuits. This can happen when the air cylinder 30 is in the vertical position with a large load on the end of the cylinder rod 38. This will require a greater air pressure to lift the load than to lower the load. The small pressure required to lower the load may not be large enough to pilot the cartridge 200 open, so adjusting the spring pressure for a lower pressure operation will result in smoother operation.

Adjusting the spring pressure to a higher force will also make the air cylinder stop faster. In some cases due to system design, the exhaust pressure cannot escape fast enough, causing the cartridge 200 to stay open. When the pressure drops low enough where the end cap spring 256 can overcome the pilot pressure, the cartridge 200 will close. The spring force on the cartridge 200 is increased by turning an adjusting screw 138 clockwise. Increasing the force on the cartridge 200 will cause the cartridge 200 to close faster. A set screw 139 is supplied for each cartridge 200 in order to lock the respective adjusting screw 138 in place.

### V. Cascaded Manifold System

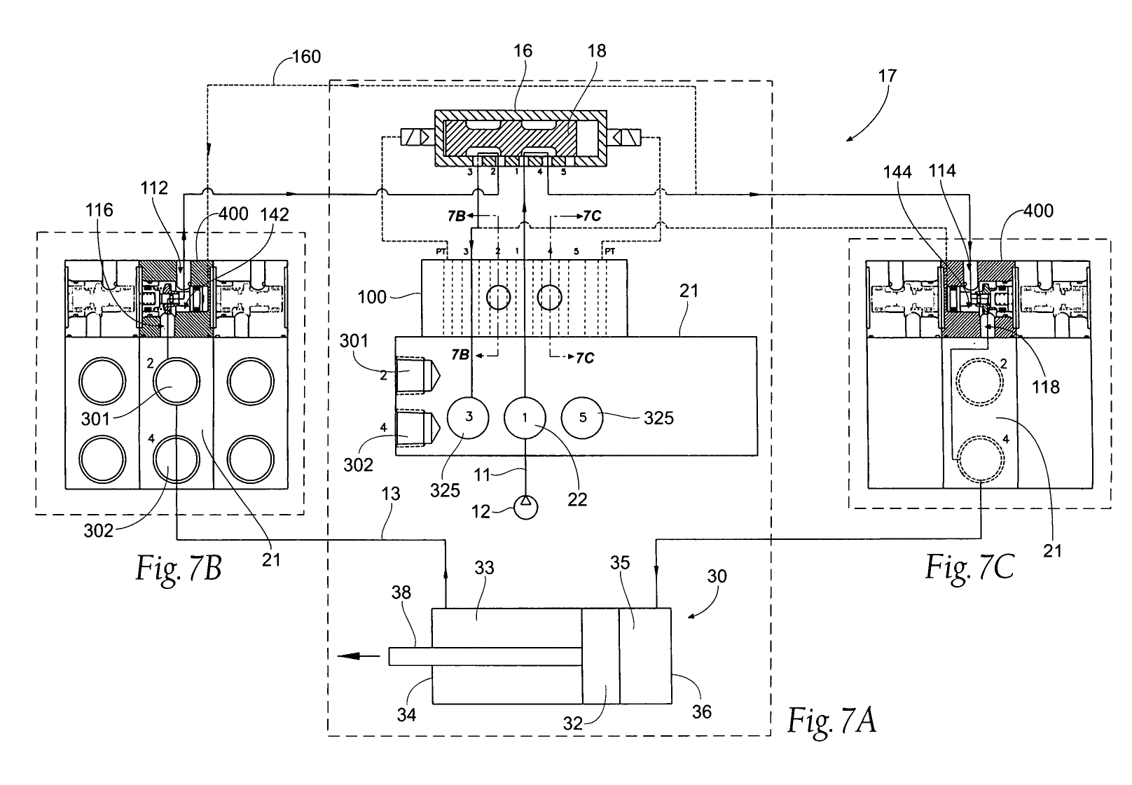

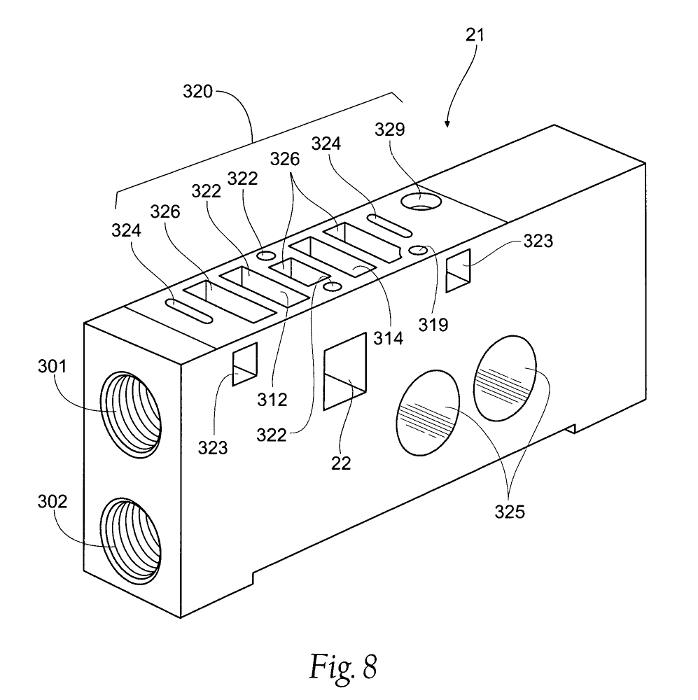

Turning now to FIGS. 7A, 7B and 7C, a second system 17 according to the present invention is shown. It may be desirable to cascade two or more stackable manifolds 21 adjacent to each other. The system 17 operates the same as the first system 10, the only exception being that a plurality of manifolds 21 for controlling a plurality of working loads, such as the cylinder 30, are disposed adjacent each other. An example of such a manifold 21 is shown in FIG. 8. Generally this type of manifold 21 has a plurality of lateral ports that are in fluid communication with at least substantially identical lateral ports of neighboring manifolds 21. The lateral ports may include a supply port 22, solenoid control ports 323, and exhaust ports 325. Also provided on the manifold 21 is a solenoid interface 320. The solenoid interface 320 includes solenoid control ports 324, exhaust ports 326, a first circuit port 312 and a second circuit port 314.

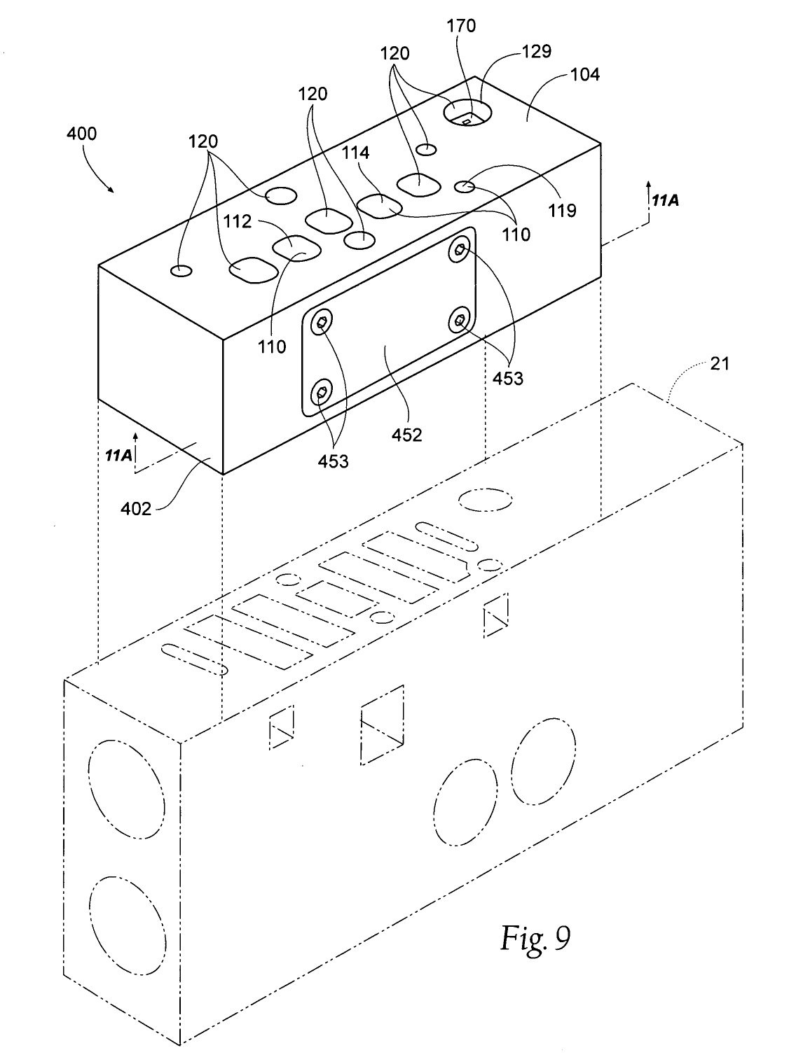

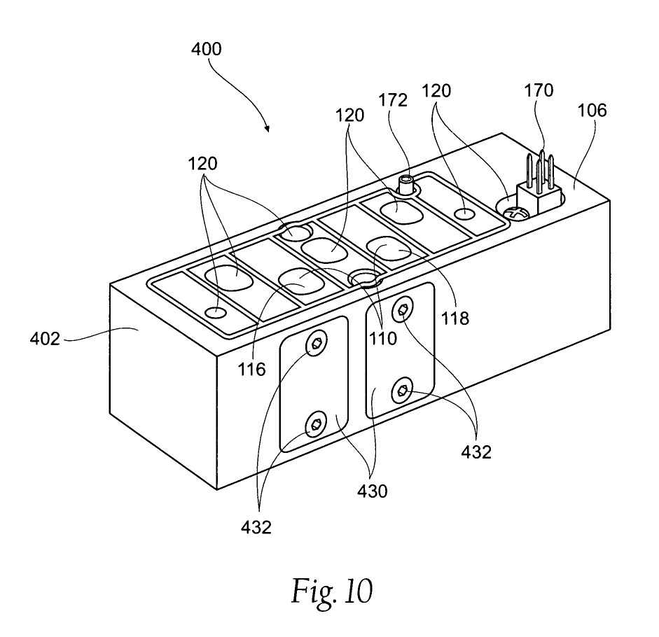

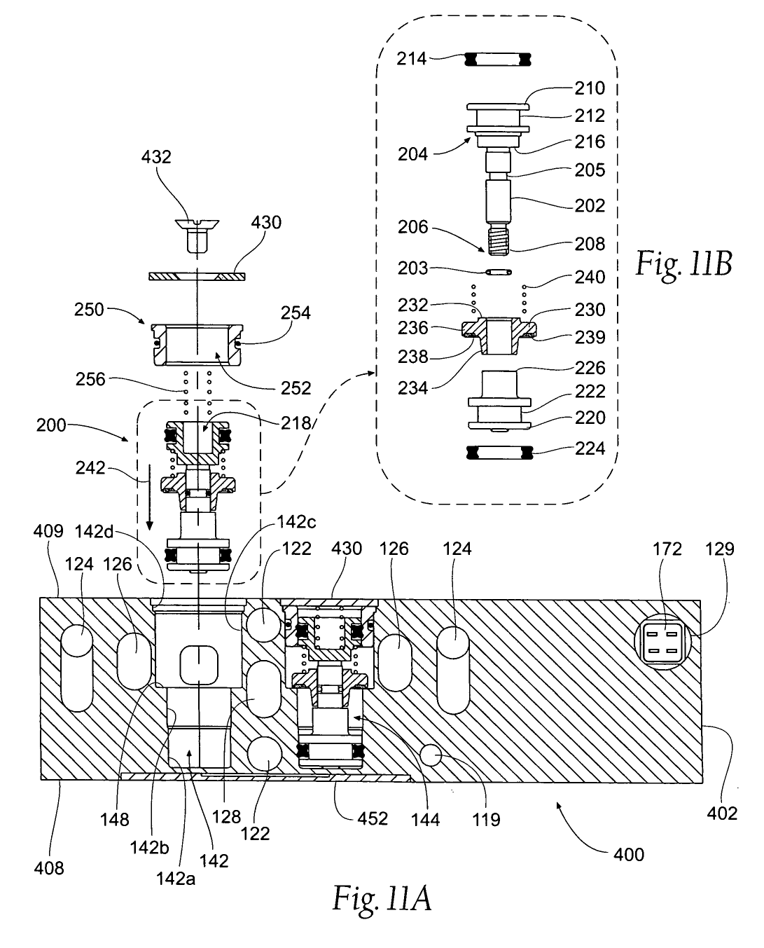

Like in the first system 10, a flow control solenoid 16 would normally be placed directly adjacent the solenoid interface 320. In this system 17, however, a fourth embodiment 400 of a valve according to the present invention is placed between the manifold 21 and a flow control solenoid 16. The fourth valve embodiment 400 is depicted in FIGS. 9, 10, 11A, 11B and 12. Generally, the valve body 402 of this embodiment 400 is substantially the same as the valve body 102 of the first embodiment 100. The primary difference between this embodiment 400 and the first embodiment 100 is that this embodiment 400 includes substantially planar right and left sides 408,409. That is, the first embodiment 100 included a manual release mechanism 150 protruding from its right side 108 and a piston plate 130 or other optional features protruding from the left side 109. Due to the nature of the stacking manifolds 21, however, such protrusions are undesirable as they interfere with adding valves onto each adjacent manifold.

Accordingly, to render the sides 408,409 substantially planar, the fourth embodiment 400 incorporates a recessed crossover channel cover 452 on the right side 408 and a pair of recessed piston plates 430 on the left side 409. The crossover channel cover 452 generally serves to cover one end of the cartridge bores 142,144, as well as provide the fluid pilot channels 164,168, generally in the same manner in which they are provided by the manual release cover 152. The crossover channel cover 452 may be secured to the valve body 402 with countersunk threaded fasteners 453. The recessed piston plates 430 generally serve the same purpose as the piston plate 130, which is to provide a stationary abutment for the piston bias spring 256 and to at least partially contain the piston cartridge 200 in the cartridge bore 142 or 144. The recessed piston plates 430 may be secured to the valve body 402 with countersunk threaded fasteners 432.

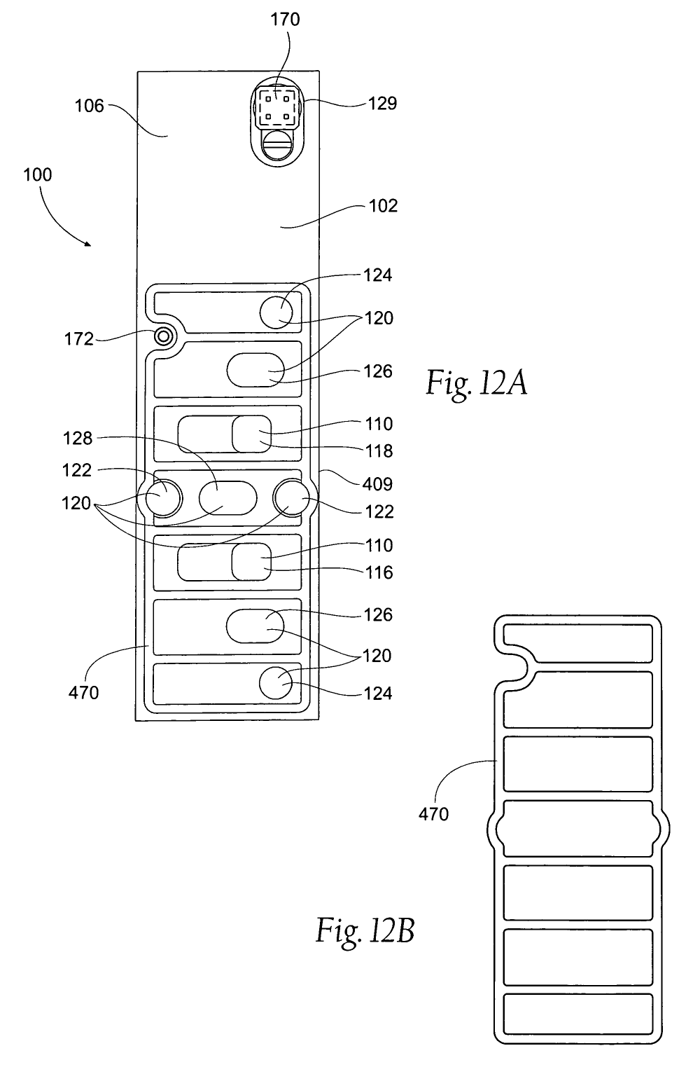

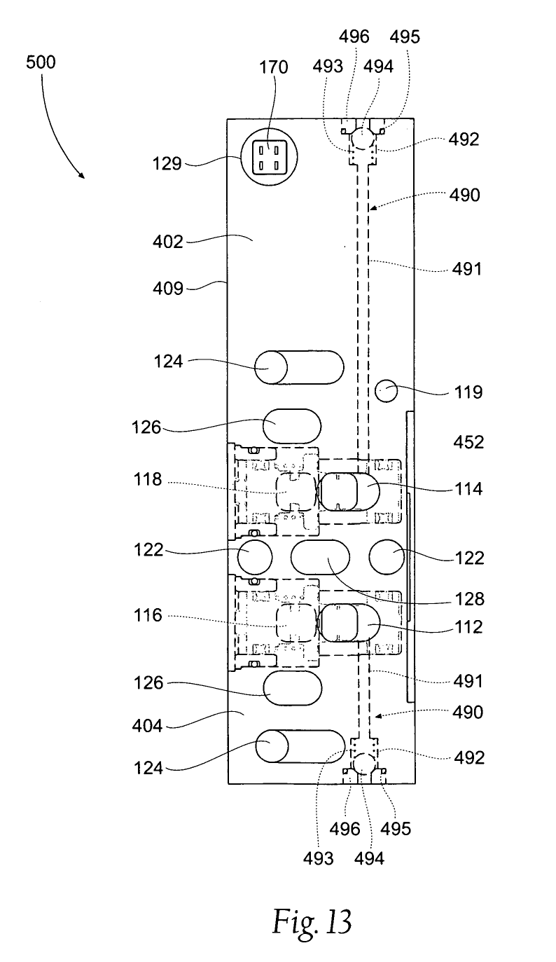

FIG. 12A depicts a bottom plan view of the fourth embodiment 400 of a valve according to the present invention. The valve body 402, like the valve body 102 of the first embodiment 100, preferably includes a gasket groove 480 formed partially into the bottom surface 406 of the body 402. Disposed at least partially in the gasket groove 480 is a preferably elastomeric gasket 482 as shown in FIG. 12B. Also, in FIG. 12A, it is to be noted that into the bottom surface 406 of the valve body 402, the third reentrant bore 116, the fourth reentrant bore 118, the exhaust throughbores 126, and the supply air throughbore 128 may be provided in a standardized interface orientation, such as that disclosed by the International Organization for Standardization (ISO) specification 15407-2 (or 15407-1), or an orientation compatible therewith. Such orientation may be utilized with any of the valve embodiments disclosed herein.

FIG. 13 depicts a fifth embodiment 500 of a valve according to the present invention. The fifth embodiment 500 generally comprises the fourth embodiment 400, with the inclusion of a manual release mechanism 490 for each cartridge bore 142,144. Each manual release mechanism 490 includes a reentrant release bore 491 extending through an outside surface of the valve body 402 and into one of the cartridge bores 142 or 144. The release bore 491 preferably includes a first counterbore 492 into which a release bias spring 493 and a release plug 494, the release bias spring 493 biasing the plug 494 away from the respective cartridge bore 142 or 144. The release bore 491 also preferably includes a second counterbore 495 into which a release plug collar 496 is secured, such as by being press fit or threaded therein. In this arrangement, in normal operation, the release bias spring 493 acts within the first counterbore 492 to bias the release plug 494 against the release plug collar 496, thereby preventing any leakage. However, when desirable to manually release air pressure from a cartridge bore 142 or 144, the force of the release bias spring 493 may be overcome by exerting pressure against the release plug 494 from outside the valve body 402, thereby forcing the release plug 494 away from the release plug collar 496, thereby allowing air to escape from the cartridge bore 142 or 144 through the reentrant release bore 491, around the release plug 494 and out to the atmosphere. Also, in FIG. 13, it is to be noted that into the top surface 404 of the valve body 402, the first reentrant bore 112, the second reentrant bore 114, the exhaust throughbores 126, and the supply air throughbore 128 may be provided in a standardized orientation, such as that disclosed by the International Organization for Standardization (ISO) specification 15407-2 (or 15407-1). Such orientation may be utilized with any of the valve embodiments disclosed herein.

The foregoing is considered as illustrative only of the principles of the invention. Furthermore, since numerous modifications and changes will readily occur to those skilled in the art, it is not desired to limit the invention to the exact construction and operation shown and described. For instance, it will occur that various combinations of the features herein described may be accommodated. For instance, the manual release mechanism 150 of the first valve embodiment 100 may be adapted for use with the second valve embodiment 400, instead of the recessed crossover channel cover 452. Also, while the preferred embodiment has been generally described as a pneumatic linear actuator, it is to be understood that an embodiment of the present invention may utilize or be utilized with any fluid motor. Furthermore, while the preferred embodiment has been described in connection with air as the fluid, it is to be understood that a valve according to the present invention would also function with other fluids such as oil and water. While the preferred embodiment has been described, the details may be changed without departing from the invention, which is defined by the claims.

I claim:

1. A valve comprising:
a valve body including,
a first reentrant bore formed into said valve body;
a second reentrant bore formed into said valve body;
a third reentrant bore formed into said valve body;
a fourth reentrant bore formed into said valve body;
a first cartridge bore in fluid communication with said first and said third reentrant bores;
a second cartridge bore in fluid communication with said second and said fourth reentrant bores;
a first piston cartridge disposed at least partially within said first cartridge bore;
a second piston cartridge disposed at least partially within said second piston bore, each of said first piston cartridge and said second piston cartridge comprising:
a longitudinal piston rod;
a first piston head secured to one end of said piston rod;
a second piston head secured to a second end of said piston rod;
a poppet member slidably disposed on said piston rod; and
a poppet bias spring biasing said poppet member in a poppet bias direction;
a first fluid channel in fluid communication with said first reentrant bore and said second cartridge bore; and
a second fluid channel arranged in a nonintersecting relationship with said first fluid channel, wherein said second fluid channel is in fluid communication with said second reentrant bore and said first cartridge bore.

2. A valve according to claim 1, wherein said valve body is a unitary member.

3. A valve according to claim 2, wherein said valve body is at least substantially parallelepiped in shape, including a front surface, back surface, top surface, bottom surface, left surface and right surface.

4. A valve according to claim 3, wherein said cartridge bores extend through and include said left surface and said right surface.

5. A valve according to claim 4, wherein said first reentrant bore and said second reentrant bore are formed into said valve body through said top surface.

6. A valve according to claim 5, wherein said third reentrant bore and said fourth reentrant bore are formed into said valve body through said bottom surface.

7. A valve according to claim 3 further including a plurality of nonintersecting throughbores formed through and including said bottom surface and said top surface.

8. A valve according to claim 1 further including a plurality of nonintersecting throughbores formed through said valve body.

9. A valve according to claim 8, wherein said plurality of nonintersecting throughbores comprises three nonintersecting throughbores.

10. A valve according to claim 9, wherein said plurality of nonintersecting throughbores comprises five nonintersecting throughbores.

11. A valve according to claim 1, further comprising:
a manual release mechanism, said manual release mechanism comprising:
a manual release cover including a pilot channel formed therein;
a manual release gasket including a first plunger aperture, a second plunger aperture and a gasket pilot hole formed therethrough, wherein said gasket pilot hole is in fluid communication with said pilot channel;
a first manual release plunger extending through said manual release cover and through said first plunger aperture;
a second manual release plunger extending through said manual release cover and through said second plunger aperture,
wherein said manual release cover is coupled to said valve body to cover one end of said cartridge bores and said gasket is situated between a portion of said manual release cover and said valve body, and
further wherein said first manual release plunger is contactable with said first piston cartridge and said second manual release is contactable with said second piston cartridge.

12. A valve according to claim 1 further comprising:
a flow control mechanism, said flow control mechanism comprising:
a mounting plate including a first adjusting aperture and a second adjusting aperture formed therethrough;
a first threaded adjusting screw extending through said first adjusting aperture;
a second threaded adjusting screw extending through said second adjusting aperture;
a first lock nut threaded onto said first adjusting screw and adapted to selectively prevent rotation of said first adjusting screw with respect to said mounting plate;
a second lock nut threaded onto said second adjusting screw and adapted to selectively prevent rotation of said second adjusting screw with respect to said mounting plate,
wherein said mounting plate is coupled to said valve body to cover one end of said cartridge bores, and
further wherein said first adjusting screw extends into said first cartridge bore and said second adjusting screw extends into said second cartridge bore.

13. A system comprising:
a fluid controlled actuator comprising a first fluid chamber and a second fluid chamber;
a manifold comprising:
a first fluid port in fluid communication through a first fluid line with said first chamber;
a second fluid port in fluid communication through a second fluid line with said second chamber;
a third fluid supply port;
a first check valve having a first check valve input, a first check valve output, and a first check valve pilot input, wherein said first check valve output is in fluid communication with said first fluid port;
a second check valve having a second check valve input, a second check valve output, and a second check valve pilot input, wherein second check valve output is in fluid communication with said second fluid port, and further wherein said second check valve input is in fluid communication with said first check valve pilot input, and said second check valve pilot input is in fluid communication with said first check valve input; and
a fluid control solenoid assembly in fluid communication with said fluid supply port, including a fluid flow control spool that is moveable between
a first position in which said fluid supply port is in fluid communication with said first check valve input, and
a second position in which said fluid supply port is in fluid communication with said second check valve input.

14. A system according to claim 13, wherein said fluid controlled actuator is a linear actuator comprising:
a plunger coupled to an actuating rod,
wherein said first chamber is a plunger chamber located on a first side of said plunger and said second chamber is a rod chamber located on a second side of said plunger.

15. A system according to claim 13, wherein, when a supply fluid pressure in said fluid supply port is lost, said first check valve and said second check valve are closed.

16. A system according to claim 15, wherein, when said fluid control solenoid assembly is in either of said first and second positions and when said supply fluid pressure is greater than either of said first fluid pressure or said second fluid pressure by a predetermined flow amount, respectively, both check valves are opened.

17. A system according to claim 16, wherein, when said fluid control solenoid assembly is in said first position and when said supply fluid pressure is greater than said first fluid pressure, said supply fluid flows from said supply fluid port through said first check valve, through said first fluid line and into said first chamber, and a first exhaust fluid flows from said second chamber, through said second fluid line and through said second check valve.

18. A system according to claim 17, wherein, when said fluid control solenoid assembly is in said second position and when said supply fluid pressure is greater than said second fluid pressure, said supply fluid flows from said supply fluid port through said second check valve, through said second fluid line and into said second chamber, and exhaust fluid flows from said first chamber, through said first fluid line and through said first check valve.
